(19) United States
(12) Patent Application Publication
(10) Pub. No.: US 2018/0147754 A1
(43) Pub. Date: May 31, 2018

(54) UNIFORM TEMPERATURE ROLL-EXTRUSION FORMING SYSTEM AND UNIFORM TEMPERATURE ROLLER STRUCTURE THEREOF

(71) Applicant: Tzu-Chi LIN, Taipei (TW)

(72) Inventor: Tzu-Chi LIN, Taipei (TW)

(73) Assignee: Tzu-Chi LIN

(21) Appl. No.: 15/696,691

(22) Filed: Sep. 6, 2017

(30) Foreign Application Priority Data
Nov. 28, 2016 (TW) 105139129

(51) Int. Cl. B29C 43/52; B29C 43/24; B29C 43/46

(52) U.S. Cl. CPC B29C 43/52; B29C 43/46; B29C 43/24

(57) ABSTRACT

A uniform temperature roll-extrusion forming system and a uniform temperature roller structure thereof are provided. The uniform temperature roll-extrusion forming system includes: a pressure roller and a uniform temperature roller. The uniform temperature roller includes: a roller body which has a uniform temperature chamber partitioned into a first chamber, a second chamber, and a third chamber, wherein the chambers are independent from one another; a pair of rotating shafts formed on two side plates of the roller body and internally provided with a flow channel communicated with the first chamber and the third chamber; and a plurality of heat exchange pipes arranged in the second chamber, wherein each heat exchange pipe is communicated with the first chamber and the third chamber; wherein the second chamber is a closed space and used for being internally provided with at least one supercritical fluid.

### BACKGROUND OF THE INVENTION

### 1. Technical Field

The present invention relates to a uniform temperature roll-extrusion forming system and a uniform temperature roller structure thereof, and more particularly relates to a uniform temperature roll-extrusion forming system used for manufacturing a thin-film product and a uniform temperature roller structure thereof.

### 2. Description of Related Art

Coated paper is a composite material formed by coating a surface of paper with plastic particles through a casting machine, and the composite material has main characteristics of oil resistance, water resistance and capability of heat seal. Different uses depend on different characteristics or processes; a coated paper process may generally include different processes such as single roll-extrusion, double roll-extrusion, co-extrusion and the like; and relevant processes achieve an economic benefit of mass production through a lamination machine.

The use of the coated paper as a food container is a very common application; when in use, in order to prevent the deformation problem, caused by the permeation of water molecules, of a paper container, relevant containers usually use an internal lamination technology to prevent liquid from contacting the paper; and at present, a majority of the commercially-available paper containers use polyethylene (PE) for lamination, but the heat resistance of the PE lamination is about 85° C. Another two conventional laminations are polypropylene (PP) and polylactic acid or polylactide (PLA). PP can resist the heat up to 135° C. If PLA is used for laminating a paper cup, it is a most-environment-friendly application; and in combination with top-grade original paper, the PLA internally-laminated paper cup can be thrown at a garbage dump and can be naturally degraded after a period of time.

Besides the manufacturing of the coated paper, a lot of thin-film products such as rubberized fabrics, cotton cloth, synthesized leather, etc. always need a process of heating or dissipating heat from the surface of the product in different production processes. However, a known hot pressing roller or a known heat dissipation roller belongs to the mechanical heat conduction, so that there is always the problem of non-uniform heating, and sometimes the quality and qualification rate of the product may be severely affected.

### SUMMARY OF THE INVENTION

The present invention is to solve the problem of how to provide a rapid and uniform-temperature heating or heat dissipation mechanism to exchange the heat of an article to be manufactured in the heating or heat dissipation process of any article to be manufactured.

The present invention provides a uniform temperature roll-extrusion forming system, comprising: a pressure roller; and a uniform temperature roller which is arranged at a relative position where the uniform temperature roller extrudes at least one film body together with the pressure roller, wherein the uniform temperature roller comprises: a roller body having a uniform temperature chamber, wherein a pair of separation plates is arranged in the uniform temperature chamber to partition the uniform temperature chamber into a first chamber, a second chamber, and a third chamber which are independent from one another; a pair of rotating shafts which are respectively formed on two side plates of the roller body, wherein each rotating shaft is internally provided with a flow channel, and the flow channels are respectively communicated with the first chamber and the third chamber; and a plurality of heat exchange pipes which are arranged in the second chamber, wherein two ends of each heat exchange pipe are respectively communicated with the first chamber and the third chamber; wherein the second chamber is a closed space and used for being internally provided with at least one supercritical fluid.

The present invention further provides a uniform temperature roller structure, comprising: a roller body having a uniform temperature chamber, wherein a pair of separation plates is arranged in the uniform temperature chamber to partition the uniform temperature chamber into a first chamber, a second chamber, and a third chamber which are independent from one another; a pair of rotating shafts which are respectively formed on two side plates of the roller body, wherein each rotating shaft is internally provided with a flow channel, and the flow channels are respectively communicated with the first chamber and the third chamber; and a plurality of heat exchange pipes which are arranged in the second chamber, wherein two ends of each heat exchange pipe are respectively communicated with the first chamber and the third chamber; wherein the second chamber is a closed space and used for being internally provided with at least one supercritical fluid.

By practicing the present invention, at least the following progressive effects can be achieved:
1. As long as an input medium is replaced, the heating or the heat dissipation process can be achieved by adjustment;
2. The heat energy can be rapidly and uniformly diffused and transferred;
3. An uniform heating or heat dissipation effect can be achieved, so that the product quality and the qualification rate can be improved; and
4. Since the temperature uniformity is improved, the metal fatigue caused by heat expansion and cold shrinkage can be avoided, so that the service life of the roller can be prolonged.

### BRIEF DESCRIPTION OF THE SEVERAL VIEWS OF THE DRAWINGS

FIG. 1 is schematic diagram illustrating a uniform temperature roll-extrusion forming system for lamination according to an embodiment of the present invention;

FIG. 2A is a diagram illustrating a uniform temperature roller, a rubber pressure roller and a uniform temperature roller according to an embodiment of the present invention;

FIG. 2B is a diagram illustrating a double uniform temperature rollers according to an embodiment of the present invention;

FIG. 2C is a diagram illustrating the uniform temperature roller applied on an object to be processed independently according to an embodiment of the present invention;

FIG. 3 is a sectional view illustrating a uniform temperature roller according to an embodiment of the present invention;

FIG. 4 is a sectional view of an A-A profile of FIG. 3;

FIG. 5 is a sectional view of an B-B profile of FIG. 4; and

FIG. 6 is a sectional view illustrating the uniform temperature roller with a heat exchange pipe further having a heat exchanging fin according to an embodiment of the present invention.

### DETAILED DESCRIPTION OF THE INVENTION

In order to further describe technical means adopted for achieving desired objectives and efficacies of the present invention, specific implementation ways, structures, features and efficacies proposed according to the present invention are described below in combination with accompanying drawings and preferred embodiments.

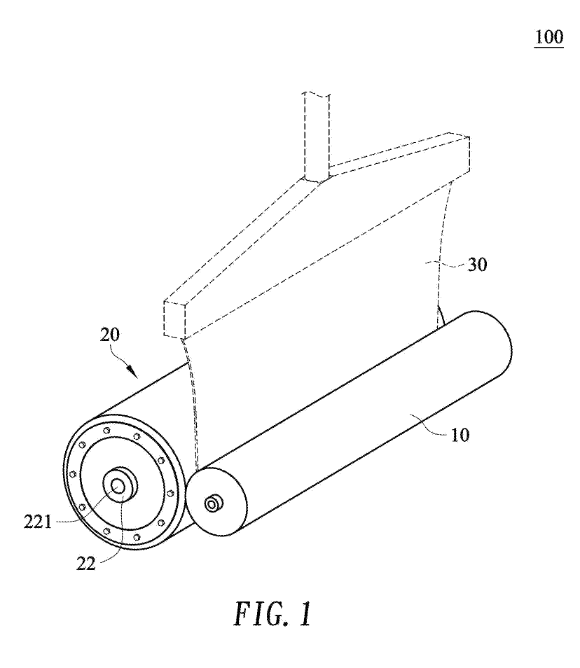

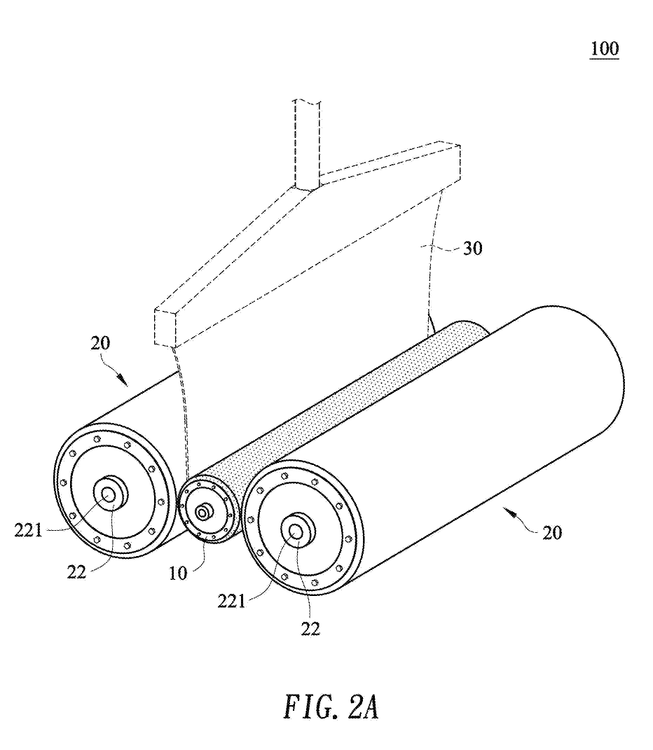

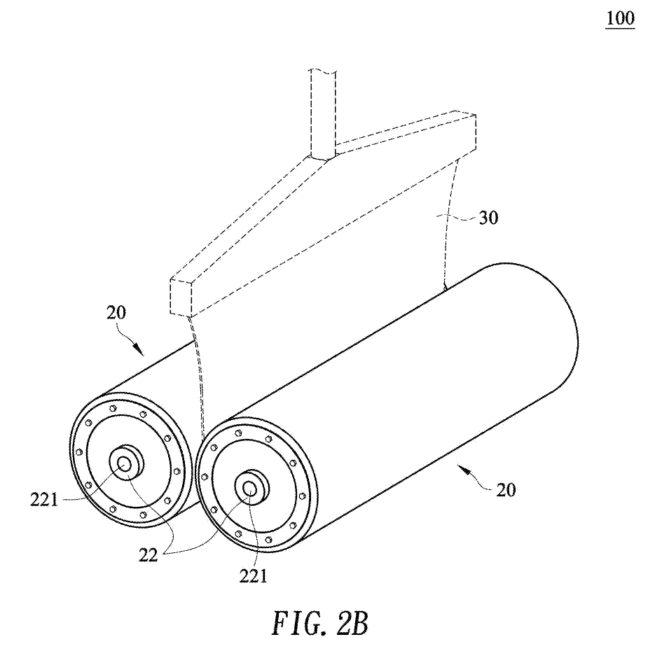

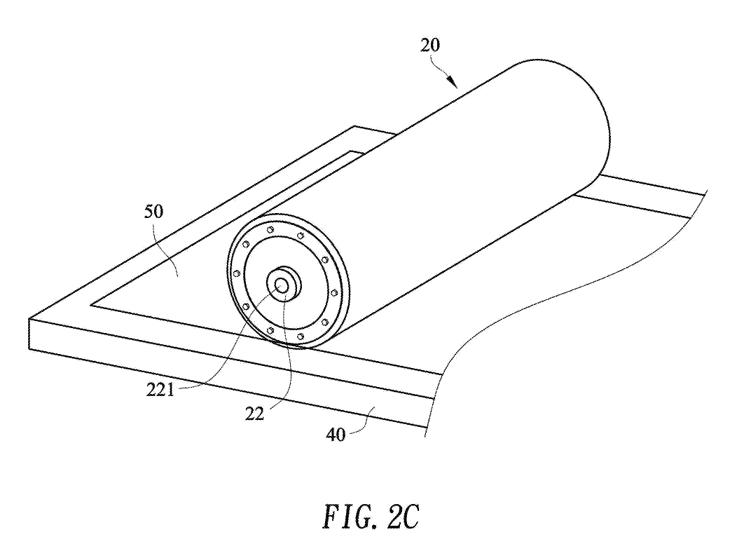

As shown in FIG. 1, FIG. 2A, FIG. 2B and FIG. 2C, the present embodiment is a uniform temperature roll-extrusion forming system 100 and a uniform temperature roller structure 20 thereof; the uniform temperature roller 20 of the present embodiment may produce the uniform-temperature heating in the heating process, and may also have an uniform-temperature heat dissipation efficacy in the cooling process; and furthermore, the uniform temperature roller 20 may be used individually, and may also be used in cooperation with a pressure roller 10.

The uniform-temperature roll-extrusion forming system 100 includes a pressure roller 10 and a uniform temperature roller 20. The uniform temperature roller structure 20 includes a roller body 21, a pair of rotating shafts 22 and a plurality of heat exchange pipes 23.

The pressure roller 10 has a main function that enables the rollers 10 and 20 to effectively interact with a film body 30 to be processed, such as roll-extrusion, heat dissipation or heating, and the like, when a product is manufactured. Thus, an appropriate pressure must be applied onto the film body 30. Therefore, the pressure roller 10 must be designed. The pressure roller 10 generally may be a rubber roller or a metal roller; further, the pressure roller 10 may be a pressure roller 10 only providing pressure, and may also be a pressurizing uniform temperature roller 20 simultaneously having a pressurizing function and a heating/heat dissipation function.

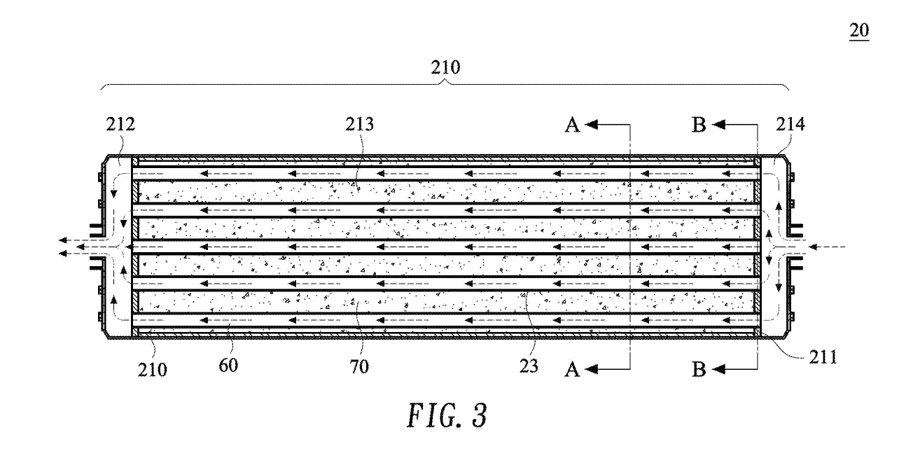

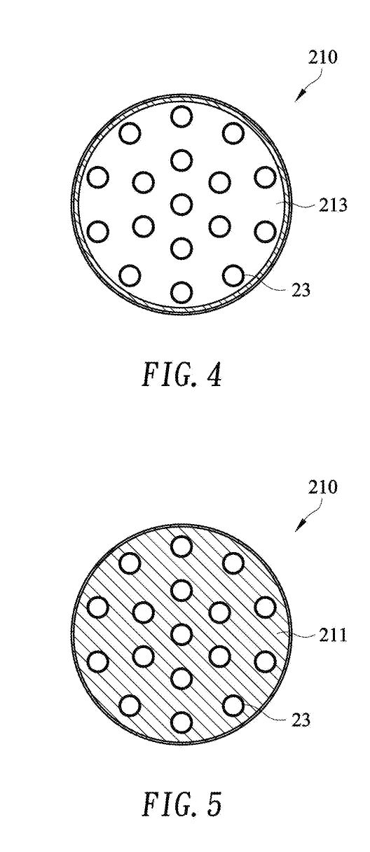

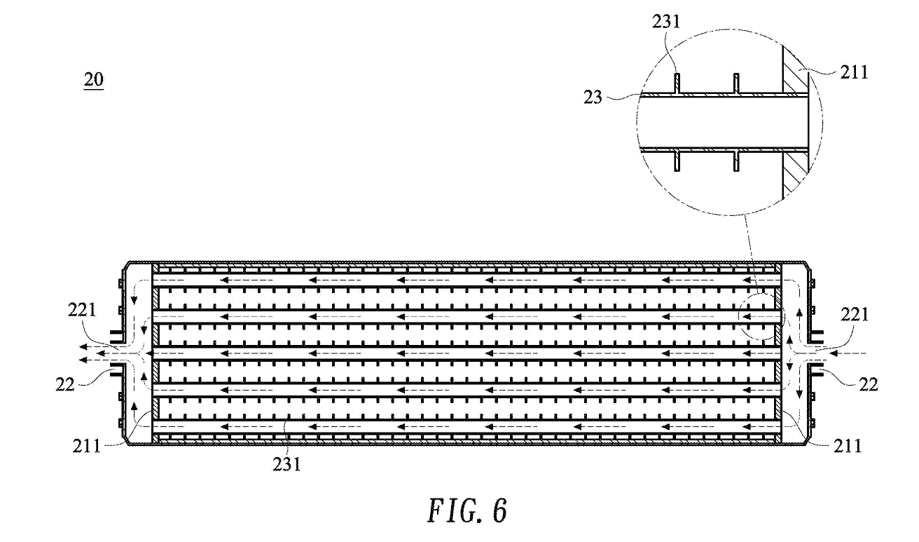

As shown in FIG. 3, the uniform temperature roller 20 is mainly arranged at a relative position where the uniform temperature roller 20 can extrude at least one film body 30 together with the pressure roller 10, so that the uniform temperature roller 20 and the pressure roller 10 can cooperatively clamp the film body 30 to be processed. The film body 30 can be effectively manufactured in this way, and generally, the uniform temperature roller 20 is usually a metal uniform temperature roller 20.

However, in some product processes, the uniform temperature roller 20 may be used separately without the pressure roller 10. For example, when the uniform temperature roller 20 acts on an object 50 placed on a platform 40, the uniform temperature roller 20 can be used separately without the pressure roller 10.

The uniform temperature roller 20 includes a roller body 21. The roller body 21 can be a cylindrical hollow shell and generally utilizes a metal roller. The roller body 21 has a uniform temperature chamber 210, wherein a pair of separation plates 211 is arranged in the uniform temperature chamber 210 and the separation plates 211 are arranged at two sides of the uniform temperature chamber 210, so that the uniform temperature chamber 210 is partitioned into a first chamber 212, a second chamber 213, and a third chamber 214, which are independent from one another. The first chamber 212 and the third chamber 214 are used for enabling the temperature regulating medium 60 to flow rapidly, and the second chamber 213 is mainly used for enabling the roller body 21 to achieve uniform temperature rapidly.

The second chamber 213 is designed as a closed pressure-resisting space. In order to enable the entire roller body 21 to rapidly achieve the heat uniformity, the second chamber 213 may be filled with at least one supercritical fluid 70. Because the supercritical fluid 70 has properties of a gaseous state with low surface tension, low viscosity, and high diffusivity, the second chamber 213 with the supercritical fluid 70 can rapidly and effectively achieve an overall uniform temperature effect.

In the present embodiment, the supercritical fluid 70 is filled in the second chamber 213 and contacts the heat exchange pipes 23 in a large area, so that the temperature regulating medium 60 flowing in the heat exchange pipes 23 can effectively control the temperature of the roller body 21, thereby enabling the uniform temperature roller 20 to have uniform-temperature heating or uniform-temperature heat dissipation function.

Further, the supercritical fluid 70 of the present embodiment may be the supercritical fluid 70 that is one or a combination of carbon dioxide, water, methane, ethane, propane, ethylene, propylene, methanol, ethanol or acetone, and the like, and each supercritical fluid 70 has a different critical temperature, so that with respect to the selection of the supercritical fluid 70, different types of supercritical fluids 70 can be selected according to an acting temperature of the uniform temperature roller 20.

The rotating shafts 22 are respectively formed on two side plates 215 of the roller body 21 so as to enable the roller body 21 to rotate. Further, in order to enable the roller body 21 to perform the heating or heat dissipation, the temperature regulating medium 60 such as hot water, coolant or kerosene and the like is effectively input to or output from the roller body 21 so as to perform the heat exchange. Therefore, a flow channel 221 is arranged in each rotating shaft 22, and the flow channels 221 are respectively communicated with the first chamber 212 and the third chamber 214, so that the temperature regulating medium 60 can be effectively unfolded or gathered in the first chamber 212 and the third chamber 214.

In order to enable the temperature regulating medium 60 to effectively act in the second chamber 213, the plurality of heat exchange pipes 23 is arranged in the second chamber 213, wherein two ends of each heat exchange pipe 23 are respectively communicated with the first chamber 212 and the third chamber 214, so that the temperature regulating medium 60 can rapidly flow between the first chamber 212 and the third chamber 214, and the heat exchange can be carried out through the heat exchange pipes 23. Moreover, in order to improve the heat exchange effect, a plurality of heat exchange fins 231 may be further formed on at least one heat exchange pipe 23 so as to increase the heat exchange area.

In order to effectively supplement, adjust or replace the supercritical fluid 70, one side plate 215 of the roller body 21 may be provided with a check valve 216, and the check valve 216 is communicated with the second chamber 213, so that the supercritical fluid 70 in the second chamber 213 can be rapidly supplemented, adjusted or replaced through the check valve 216.

The above descriptions are just preferable embodiments of the present invention and are not intended to limit the present invention in any form; although the present invention is already disclosed with the above preferable embodiments, the preferable embodiments are not used to limit the present invention; those skilled in the art can alter or modify the method and technical content disclosed above to obtain equivalent embodiments without departing from the scope of the technical solution of the present invention; however, the description without departing from the technical solution of the present invention and any simple alterations, equivalent changes and modifications made to the above embodiments according to the technical nature of the present invention shall still fall within the scope of the technical solution of the present invention.

What is claimed is:

1. A uniform temperature roll-extrusion forming system, comprising:
a pressure roller; and
a uniform temperature roller which is arranged at a relative position where the uniform temperature roller extrudes at least one film body together with the pressure roller, wherein the uniform temperature roller comprises:
a roller body having a uniform temperature chamber, wherein a pair of separation plates is arranged in the uniform temperature chamber to partition the uniform temperature chamber into a first chamber, a second chamber, and a third chamber which are independent from one another;
a pair of rotating shafts which are respectively formed on two side plates of the roller body, wherein each rotating shaft is internally provided with a flow channel, and the flow channels are respectively communicated with the first chamber and the third chamber; and
a plurality of heat exchange pipes which are arranged in the second chamber, wherein two ends of each heat exchange pipe are respectively communicated with the first chamber and the third chamber;
wherein the second chamber is a closed space and used for being internally provided with at least one supercritical fluid.

2. The uniform temperature roll-extrusion forming system according to claim 1, wherein the pressure roller is a rubber roller or a metal roller or a pressurizing uniform temperature roller.

3. The uniform temperature roll-extrusion forming system according to claim 1, wherein the uniform temperature roller is a metal uniform temperature roller.

4. The uniform temperature roll-extrusion forming system according to claim 1, wherein a plurality of heat exchange fins is formed on at least one heat exchange pipe.

5. The uniform temperature roll-extrusion forming system according to claim 1, wherein the supercritical fluid is one or a combination of carbon dioxide, water, methane, ethane, propane, ethylene, propylene, methanol, ethanol or acetone.

6. The uniform temperature roll-extrusion forming system according to claim 1, wherein one side plate of the roller body is provided with a check valve, and the check valve is communicated with the second chamber.

7. A uniform temperature roller structure, comprising:
a roller body having a uniform temperature chamber, wherein a pair of separation plates is arranged in the uniform temperature chamber to partition the uniform temperature chamber into a first chamber, a second chamber, and a third chamber which are independent from one another;
a pair of rotating shafts which are respectively formed on two side plates of the roller body, wherein each rotating shaft is internally provided with a flow channel, and the flow channels are respectively communicated with the first chamber and the third chamber; and
a plurality of heat exchange pipes which are arranged in the second chamber, wherein two ends of each heat exchange pipe are respectively communicated with the first chamber and the third chamber;
wherein the second chamber is a closed space and used for being internally provided with at least one supercritical fluid.

8. The uniform temperature roller structure according to claim 7, wherein the uniform temperature roller is a metal uniform temperature roller.

9. The uniform temperature roller structure according to claim 7, wherein a plurality of heat exchange fins is formed on at least one heat exchange pipe.

10. The uniform temperature roller structure according to claim 7, wherein the supercritical fluid is one or a combination of carbon dioxide, water, methane, ethane, propane, ethylene, propylene, methanol, ethanol or acetone.

11. The uniform temperature roller structure according to claim 7, wherein one side plate of the roller body is provided with a check valve, and the check valve is communicated with the second chamber.
